(19) United States
(12) Patent Application Publication
(10) Pub. No.: US 2004/0032871 A1
(43) Pub. Date: Feb. 19, 2004

(54) Switch-based modem channel sharing

(75) Inventors: Erez Sharon, Kochav Yair (IL); Benny Maytal, Mevaseret Zion (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Smartlink Ltd., Netanya (IL)

(21) Appl. No.: 10/219,359

(22) Filed: Aug. 14, 2002

(51) Int. Cl. H04L 12/28; H04L 5/16

(52) U.S. Cl. 370/400; 375/222

(57) ABSTRACT

Apparatus for data communications includes a modem front end, which processes an incoming signal so as to generate a stream of incoming digitized samples, and which processes outgoing digital samples to generate an outgoing signal. A primary client receives and processes the incoming digitized samples from the front end, and conveys the information extracted from the samples to a secondary client. The primary client also receives and processes outgoing data from the secondary client in order to generate the outgoing digital samples for the front end. The front end and clients are connected by a switch, which toggles between a first position in which it passes the incoming digitized samples from the modem front end to an input of the primary client, and a second position in which the switch passes the outgoing data from the secondary client to the input of the primary client.

### FIELD OF THE INVENTION

The present invention relates generally to modems, and specifically to high data-rate modems for use over broadband channels.

### BACKGROUND OF THE INVENTION

Modems are used for transferring information on communication lines or other communication media between two parties. The modem converts information from electrical signals on the communication line to data bits, and vice versa. In conventional modems, all the signal processing operations involved in extracting the data from incoming communication line signals, as well as generating outgoing signals to send data, are performed by dedicated modem hardware circuits. In “soft modems,” some or all of these signal processing functions are performed by a host processor in a computer that is connected to the line or other media. Soft modems thus take advantage of the computational power of the host and reduce the volume and cost of hardware that is required for communications. Exemplary soft modems are described in U.S. Pat. Nos. 4,965,641 and 6,092,095, which are incorporated herein by reference.

In the past, nearly all modems used in homes and small offices operated by dial-up over telephone lines and were limited to low data rates, typically no more than 56 kbps. Recently, however, broadband modem technologies have been developed, such as Digital Subscriber Line (DSL) systems, cable modems and fixed wireless data links. Asymmetric DSL (ADSL) service, for example, offers downstream service at rates up to 8 Mbps. Further aspects of ADSL are defined in Recommendation G.992.1 of the International Telecommunication Union (ITU), which is incorporated herein by reference. In many homes and offices, a broadband data channel is shared among multiple clients, typically personal computers (PCs). This purpose is commonly achieved by connecting the clients to the broadband modem over a local area network (LAN), such as an Ethernet LAN. The modem unit is supplied with an Ethernet output. A router is attached to the Ethernet output of the modem (either as a standalone unit or integrated into the modem box), and controls communications between the modem and the different clients. A typical router of this sort has several Ethernet ports, each connecting to a different client, along with suitable switching logic for arbitrating among the clients. Alternatively, a wireless LAN may be used, with a wireless “access point” taking the place of the router.

There are several problems with using a LAN to share a broadband channel and modem resources among clients. The router or access point that must be used adds to the cost of the system. When the customer premises do not have a LAN already in place, it is also necessary to add wiring, LAN adapters and software on all the client computers that are to use the broadband channel. In addition, conventional LAN-based solutions cannot readily accommodate soft modems running on the clients, since soft modems require an uninterrupted flow of samples and significant guaranteed bandwidth.

### SUMMARY OF THE INVENTION

It is an object of some aspects of the present invention to provide improved methods and systems for sharing a data communication channel among multiple clients, and particularly to enable multiple clients to share a common broadband channel without an intervening router. Typically, the clients comprise personal computers, at least one of which serves as a soft modem for communicating over the channel. The principles of the present invention are not limited to soft modems, however, and may also be applied to systems using hardware-based modems. Similarly, while preferred embodiments described hereinbelow are directed to data communications over particular types of broadband channels, aspects of the present invention may also be applied in narrowband systems in which multiple clients share a common communication line.

In some preferred embodiments of the present invention, multiple clients share a modem front end, which is connected to transmit and receive signals over a communication medium. The front end processes incoming signals to generate a stream of digitized samples. One of the clients is chosen as the primary client, and runs soft modem software that performs the necessary data pump functions on the digitized samples so as to recover the data bits from the incoming signals. The choice of the primary client may vary, depending on which of the multiple clients is powered up and operating, as well as other factors. After processing the samples, the primary client determines whether the recovered data are for its own use or are addressed to another one of the clients. In the latter case, the primary client sends the data bits over a local connection to the other client. In the same manner, clients having outgoing data to transmit send the data bits over the local connection to the primary client, which prepares output samples and passes them to the front end for transmission.

Preferably, the local connections comprise only a single transmit line and a single receive line connecting to each of the clients and to the front end. The front end operates a simple switch in order to take control of the receive line of the primary client when it has digitized samples to be processed. No router is required, and soft modem functionality is fully supported. Optionally, two or more of the clients (or even all the clients) may be configured to run soft modem software, with appropriate changes made in the switch to support this configuration.

There is therefore provided, in accordance with a preferred embodiment of the present invention, apparatus for data communications, including:

a modem front end, which is adapted to receive an incoming signal conveying incoming information over a communication medium, and to process the incoming signal so as to generate an incoming stream of incoming digitized samples, and which is further adapted to receive an outgoing stream of outgoing digital samples carrying outgoing information, and to process the outgoing digital samples to generate an outgoing signal for transmission over the communication medium;

a primary client, having an input and an output, the primary client being adapted to receive the incoming digitized samples via the input, to process the incoming digitized samples so as to extract the information from the incoming signal, and to convey the extracted information via the output to a secondary client, the primary client being further adapted to receive outgoing data via the input from the secondary client, to process the outgoing data so as to generate the outgoing stream of outgoing digital samples, and to convey the outgoing stream of outgoing digital samples via the output to the modem front end; and

a switch, coupled to the input of the primary client, and adapted to toggle between a first position in which the switch passes the incoming digital samples from the modem front end to the input, and a second position in which the switch passes the outgoing data from the secondary client to the input.

Preferably, the modem front end is coupled to control the switch, responsive to the front end having the incoming digitized samples ready to convey to the primary client. Most preferably, the modem front end is adapted to accumulate the incoming digitized samples while the switch is in the second position, and to cause the switch to toggle to the first position upon accumulating a predetermined volume of the incoming digitized samples.

In a preferred embodiment, the modem front end and the primary and secondary clients are mutually coupled by a local area network (LAN), and the input and output of the primary client respectively include a receive input and a transmit output of the primary client on the LAN. Optionally, the secondary client is one of a plurality of secondary clients on the LAN, which are adapted to receive the extracted information from the primary client and to convey the outgoing data to the primary client over the LAN.

Preferably, the modem front end and the secondary client are both coupled to receive the extracted information and the outgoing digital samples directly from the output of the primary client.

Additionally or alternatively, the primary client is adapted to process the extracted information to determine whether the information is intended for receipt by the primary client, and to convey the extracted information to the secondary client upon determining that the information is not intended for receipt by the primary client. Preferably, the incoming information includes a destination address, and the primary client is adapted to extract the destination address from the extracted information and to determine whether the information is intended for receipt by the primary client responsive to the extracted destination address.

Typically, the outgoing data received by the primary client from the secondary client include first outgoing data, and the primary client is adapted to create second outgoing data, and to process the second outgoing data, as well as the first outgoing data, to generate the outgoing stream of outgoing digital samples.

Preferably, the primary and secondary clients include computers.

There is also provided, in accordance with a preferred embodiment of the present invention, apparatus for data communications, including:

a modem front end, which is adapted to receive an incoming signal conveying incoming information over a communication medium, and to process the incoming signal so as to generate an incoming stream of incoming digitized samples, and which is further adapted to receive an outgoing stream of outgoing digital samples carrying outgoing information, and to process the outgoing digital samples to generate an outgoing signal for transmission over the communication medium;

a plurality of clients having inputs and outputs, including a respective input and a respective output of each of the clients, each of the clients being adapted to receive the incoming digitized samples via the respective input and to process the incoming digitized samples so as to extract the information from the incoming signal, and being further adapted to process the outgoing information so as to generate the outgoing stream of outgoing digital samples and to convey the outgoing stream of outgoing digital samples via the respective output to the modem front end; and

a switch, coupled to toggle among the outputs of the clients so as to select one of the clients to convey the outgoing digital samples to the modem front end, while the inputs of all the clients are coupled simultaneously to receive the incoming digitized samples from the modem front end.

Preferably, the incoming information includes a destination address, and each of the clients has a respective address and is adapted to process the extracted information to determine whether the destination address matches its respective address, and to discard the extracted information if the destination address does not match the respective address.

There is additionally provided, in accordance with a preferred embodiment of the present invention, a method for data communications, including:

receiving an incoming signal at a modem front end, the signal conveying incoming information over a communication medium;

processing the incoming signal in the modem front end so as to generate an incoming stream of incoming digitized samples;

conveying the incoming digitized samples from the modem front end via a switch to an input of a primary client, while the switch is in a first position connecting the modem front end to the input of the primary client;

processing the incoming digitized samples in the primary client so as to extract the information from the incoming signal;

conveying the extracted information via an output of the primary client to a secondary client;

toggling the switch to a second position so as to connect the secondary client to the input of the primary client;

receiving outgoing data from the secondary client via the switch in the second position at the input of the primary client;

processing the outgoing data in the primary client so as to generate an outgoing stream of outgoing digital samples;

conveying the outgoing stream of outgoing digital samples via the output to the modem front end; and

processing the outgoing digital samples in the modem front end so as to generate an outgoing signal for transmission over the communication medium.

There is further provided, in accordance with a preferred embodiment of the present invention, a method for data communications, including:

receiving an incoming signal at a modem front end, the signal conveying incoming information over a communication medium;

processing the incoming signal in the modem front end so as to generate an incoming stream of incoming digitized samples;

conveying the incoming stream of incoming digitized samples substantially simultaneously to a plurality of clients;

toggling a switch among a plurality of positions to select one of the clients, such that in each of the positions, an output of a respective one of the clients is connected to transfer an outgoing stream of outgoing digital samples to the modem front end;

conveying the outgoing stream of outgoing digital samples from the selected one of the clients to the modem front end; and

processing the outgoing digital samples in the modem front end so as to generate an outgoing signal for transmission over the communication medium;

There is moreover provided, in accordance with a preferred embodiment of the present invention, apparatus for data communications, including:

a modem, which is adapted to receive an incoming signal conveying incoming data over a communication medium, and to process the incoming signal so as to extract the incoming data therefrom, and which is further adapted to receive an outgoing stream of outgoing data, and to process the outgoing data to generate an outgoing signal for transmission over the communication medium;

a primary client, having an input and an output, the primary client being adapted to receive the incoming data via the input and to process the incoming data to determine whether the incoming data are intended for receipt by the primary client, and to convey the incoming data via the output to a secondary client upon determining that the data are not intended for receipt by the primary client, the primary client being further adapted to receive the outgoing data via the input from the secondary client, and to convey the outgoing data via the output to the modem front end; and

a switch, coupled to the input of the primary client, and adapted to toggle between a first position in which the switch passes the incoming data from the modem to the input, and a second position in which the switch passes the outgoing data from the secondary client to the input.

Preferably, the modem is coupled to control the switch, wherein the modem is adapted to accumulate the incoming data while the switch is in the second position, and to cause the switch to toggle to the first position upon accumulating a predetermined volume of the incoming data.

Typically, the data include data packets, and wherein the primary client is adapted to determine whether the data are intended for receipt by the primary client by examining an Internet Protocol (IP) address of the data packets.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a communication system in which multiple clients share a common modem front end, in accordance with a preferred embodiment of the present invention;

FIG. 2 is a flow chart that schematically illustrates a method by which multiple clients communicate over a channel using a shared modem front end, in accordance with a preferred embodiment of the present invention;

FIGS. 3 and 4 are block diagrams that schematically illustrate communication systems in which multiple clients share a common modem front end, in accordance with further preferred embodiments of the present invention; and

FIG. 5 is a block diagram that schematically illustrates a communication system in which multiple clients share a common modem, in accordance with a preferred embodiment of the present invention.

### DETAILED DESCRIPTION OF PREFERRED EMBODIMENTS

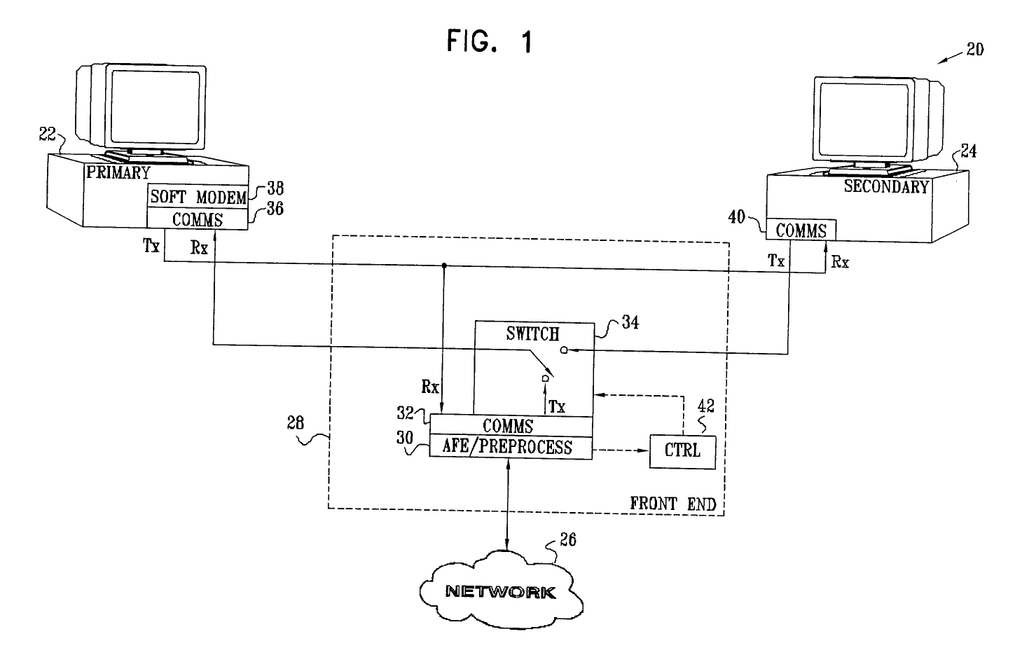

FIG. 1 is a block diagram that schematically illustrates a communication system 20, in accordance with a preferred embodiment of the present invention. The system comprises a primary client 22 and a secondary client 24, which communicate over a communication medium 26 using a shared modem front end unit 28. Typically, clients 22 and 24 comprise PCs, although computing devices of other types (for example, “smart” cable television set-top boxes) may similarly be used in this configuration. The designation of “primary” and “secondary” clients is arbitrary, depending on the configuration of client software and of local communication connections between the clients and the front end unit.

Front end unit 28 is coupled to send and receive signals over a communication medium 26, such as a telephone subscriber line. The modem functionality is divided between hardware-based front end unit 28 and software running on primary client 22. In the embodiment described hereinbelow, front end unit 28 is connected to communicate with a central office or head-end modem (not shown in this figure). In this embodiment, the front end unit and software running on primary client 22 are configured for ADSL operation, as described above, or for another of the xDSL standards. Alternatively, medium 26 may comprise a television cable, a wireless medium, or substantially any other type of network for data communications known in the art.

Signals from medium 26 are received, filtered and digitized by an analog front end (AFE) 30, as is known in the art. AFE 30 generates a stream of raw digital samples, which may be further processed in hardware by a digital preprocessing circuit. These further processing functions typically comprise the initial stages in the data pump operations that are required to extract data bits from the incoming signals. An exemplary preprocessing circuit is shown in a U.S. patent application entitled, “Modem with Distributed Functionality,” filed Mar. 7, 2002, which is assigned to the assignee of the present patent application, and whose disclosure is incorporated herein by reference.

Digital samples generated by AFE 30 are conveyed from the transmit (Tx) output of a communication adapter 32 in front end unit 28, via a switch 34, to a receive (Rx) input of a corresponding communication adapter 36 in primary client 22. Typically, adapters 32 and 36 comprise Ethernet adapters, with suitable hardware and software for communicating over an Ethernet local area network (LAN). Alternatively, substantially any type of medium and adapters suitable for local digital communications may be used to connect front end unit 28 and clients 22 and 24. The operation of switch 34 is described further hereinbelow. Modem software 38 running on primary client 22 reads out the sample values from data frames received by adapter 36, and performs the remaining data pump operations needed to extract the data from the sample stream.

Primary client 22 processes the data thus extracted from the incoming communication signals and determines, inter alia, whether the data are addressed to the primary client itself or to secondary client 24. For example, the primary client may read the destination Internet Protocol (IP) address contained in data packets that it has received in this manner in order to determine whether the address is its own. If so, the primary client retains the data. Otherwise, the primary client outputs the data via the Tx output of adapter 36 to a communication adapter 40 of secondary client 24. The Tx output of client 22 is coupled directly to the Rx inputs of both adapter 32 in front end unit 28 and adapter 40 in secondary client 24. Adapter 32 ignores the data sent by client 22 to client 24, however, either because the data are contained in frames having a destination address field designating client 24, or (if such addressing is not used) because the data are not in the sort of format expected by front end unit 28. Adapter 40 accepts the data and passes them on to be processed by the appropriate application running on client 24.

To send outgoing communication signals over medium 26, primary client 22 uses modem software 38 to convert its output data to digital samples, and then uses adapter 36 to send the samples out via its Tx output. In this case, adapter 32 in front end unit 28 accepts the samples, while adapter 40 in secondary client 24 ignores them. AFE 30 processes the samples to generate the appropriate analog signal for output over medium 26. When secondary client 24 has output data to transmit over medium 26, it passes the data via the Tx output of adapter 40 to the Rx input of adapter 36 on primary client 22. For this purpose, switch 34 is flipped so that the Tx output of adapter 40, instead of the Tx output of adapter 32, is connected to the Rx input of adapter 36. The operation of switch 34 is governed by a controller 42, depending on whether or not AFE 30 has samples ready to be sent to primary client 22. The primary client receives the data sent to it by the secondary client and converts the data, using modem software 38, to digital samples, which it then outputs to front end unit 28 as described above.

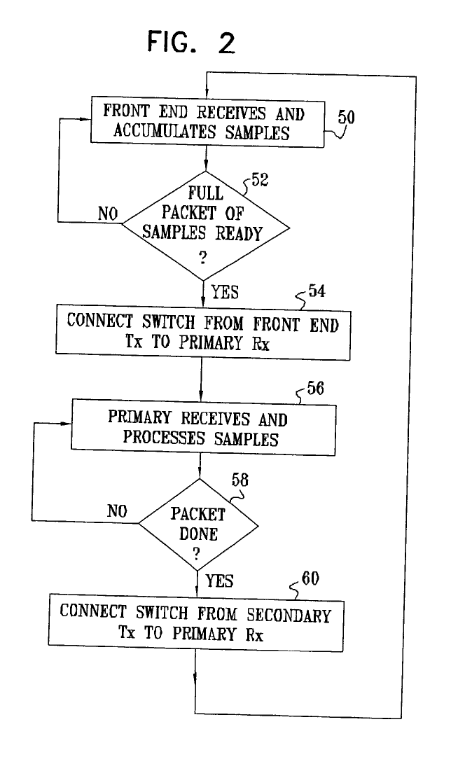

FIG. 2 is a flow chart that schematically illustrates operation of system 20 in receiving and processing incoming signals from medium 26, in accordance with a preferred embodiment of the present invention. Controller 42 normally maintains switch 34 in the position in which the Tx output of secondary client 24 is connected to the Rx input of primary client 22, so that the clients may communicate with one another at will. While switch 34 is in this position, AFE 30 receives a signal from medium 26 and generates digital samples, at a signal receiving step 50. The AFE preferably does not send the samples to primary client 22 immediately, but rather saves the samples in a buffer memory (not shown). This state of operation continues until front end unit 28 has accumulated a predetermined quantity of data, typically corresponding to a complete data frame or packet, at a packet completion step 52.

When controller 42 determines that the required complement of samples has accumulated in the buffer, it actuates switch 34 to connect the Tx output of adapter 32 in front end unit 28 to the Rx input of adapter 36 in primary client 22, at a switch connection step 54. Changing the switch position may interrupt a data transmission from secondary client 24 to primary client 22. If this occurs, application or communications software or hardware on client 24 will retry the transmission until switch 34 returns to its former position, at which time the transmission can be completed.

Primary client 22 receives the samples sent by front end unit 28, and processes the samples to extract the data carried by the signal, at a sample processing step 56. Typically, adapter 36 receives the samples and saves them in a memory of client 22 for processing by software 38, until the entire packet sent by front end unit 28 has been received and processed. Controller 42 determines that the entire packet has been sent to client 22, at a packet completion step 58. It then releases switch 34, so that the switch reconnects the Tx output of secondary client 24 with the Rx input of primary client 22, at a switch release step 60. Secondary client 24 can now resume any previous transmission that was interrupted or prevented by the action of switch 34, or may begin a new transmission when it has data ready to send. Front end unit 28 continues to receive and accumulate samples from medium 26 at step 50.

After modem software 38 has finished converting the digital samples to data bits, primary client 22 finds and analyzes header information included in the data to determine which client should actually receive this packet. Typically, client 22 checks the destination IP address of the packet against the source IP address used by its own communications software or hardware to determine whether the addresses match. Alternatively, the primary client may use other protocol addresses or may apply other criteria to the data to determine whether it should keep the data for itself. If so, the primary client uses its communication and/or application software to process the data locally. On the other hand, if the primary client does not recognize the IP destination address or other identifying criteria of the data packet it has received, it passes the packet from its Tx output to the Rx input of secondary client 24. The secondary client can then process the data, using its own communication and/or application software. Alternatively, if the secondary client, too, determines that it is not the proper addressee for the data, it will simply discard the data as erroneous.

Thus, in contrast to broadband modems known in the art, system 20 enables clients 22 and 24 to share access to communication medium 26 without the need for a router, and even without a LAN hub. These functions instead are carried out by client software and by switch 34.

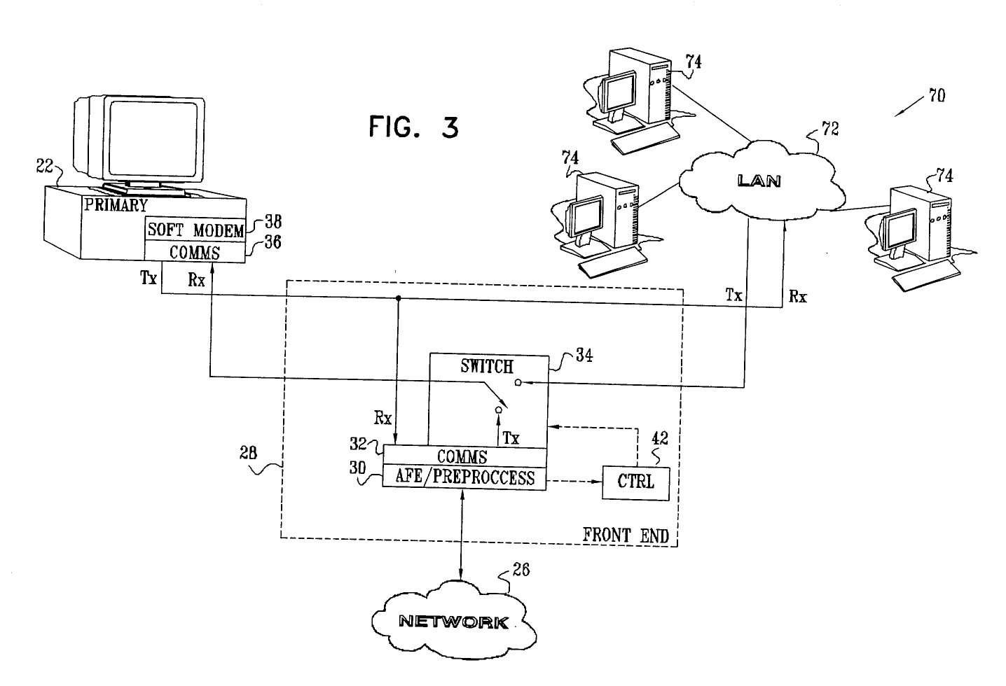

FIG. 3 is a block diagram that schematically illustrates a communication system 70, in accordance with another preferred embodiment of the present invention. This embodiment is largely similar to system 20, except that now access to communication medium 26 is shared among multiple clients 74, which are connected to primary client 22 by a LAN 72. Typically, the LAN comprises a hub or access point, as is known in the art, which distributes data frames among the clients according to their preassigned media access control (MAC) addresses. When primary client 22 receives a packet of data that is not addressed to itself, it determines which of clients 74 should receive the data, and then sends the data over LAN 72 in a data frame to the appropriate destination MAC address. Clients 74 send frames of outgoing data to primary client 22 over LAN 72 in like manner. Processing of the data and control of switch 34 are carried out in substantially the manner described above.

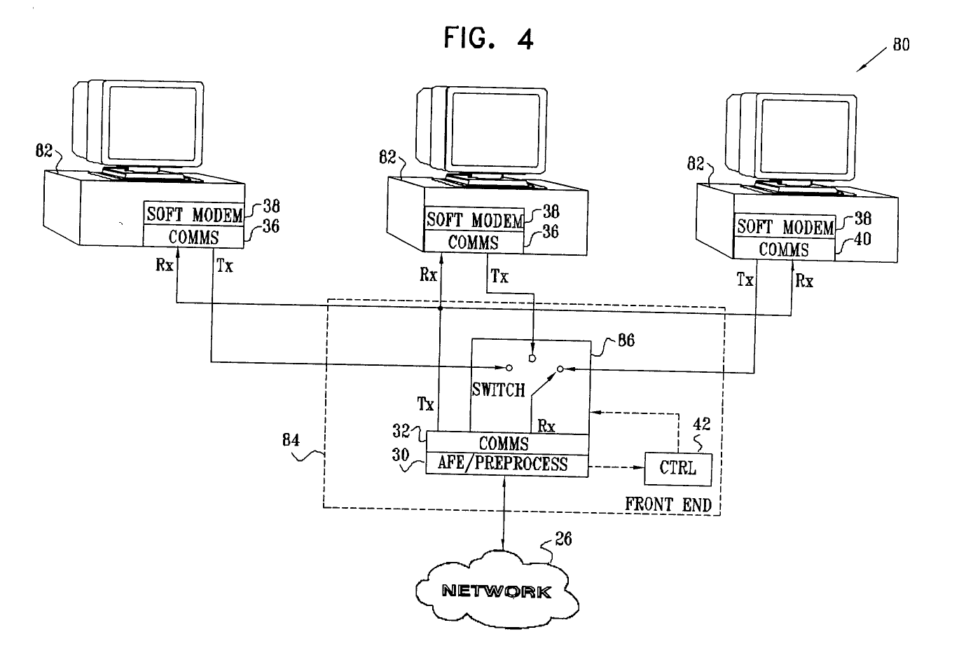

FIG. 4 is a block diagram that schematically illustrates a communication system 80, in accordance with still another preferred embodiment of the present invention. In this embodiment, each of client computers 82 has its own modem software 38. Digital samples of incoming communication signals that are generated by AFE 30 in a shared front end unit 84 are conveyed via the Tx output of the front end unit to the Rx inputs of all the clients, as shown in the figure. Modem software 38 in each of the clients processes the digital samples to extract the data bits from the incoming signals. Each client checks the destination address of each incoming data packet, to determine whether the packet is meant for its own use. If not, the client simply discards the packet.

The Tx outputs of all clients 82 are connected by a switch 86 to the Rx input of front end unit 84. Controller 42 determines which of the clients is allowed to send outgoing data samples (generated by modem software 38) for transmission over medium 26 at any given time. Preferably, clients 82 use a simple protocol to indicate to controller 42 when they have data samples to transmit, and when they have finished transmitting. If a client does not have samples to transmit at its turn for transmission, switch 86 will rotate to the next client. For example, the clients may send a signal to the controller via the Rx input of front end unit 84 when they have finished transmitting a packet. This signal causes the controller to step switch 86 through the different possible connections until one of the clients signals that it has data samples to transmit. The controller then leaves the switch in the proper position for that client to transmit its data, until the client indicates that it has completed its packet, or until a certain timeout period has passed.

Other protocols and modes of controlling switch 84 will be apparent to those skilled in the art. Note that in some transmission systems, it may be necessary for each client to invoke and carry out a retraining procedure with a peer modem (not shown) across network 26 when the switch is rotated to the client. The retraining procedure enables the client to set bit loading and other parameters to be used when the client actually begins transmitting data. Such retraining procedures are well known in the art.

By comparison with the preceding embodiments, the embodiment of FIG. 4 has the advantage that each client 82 performs its own processing, independent of the others. Therefore, if one of the clients fails, it does not substantially effect the operation of the other clients. In the preceding embodiments, by comparison, failure of primary client 22 may cut off modem access for all the other clients, as well.

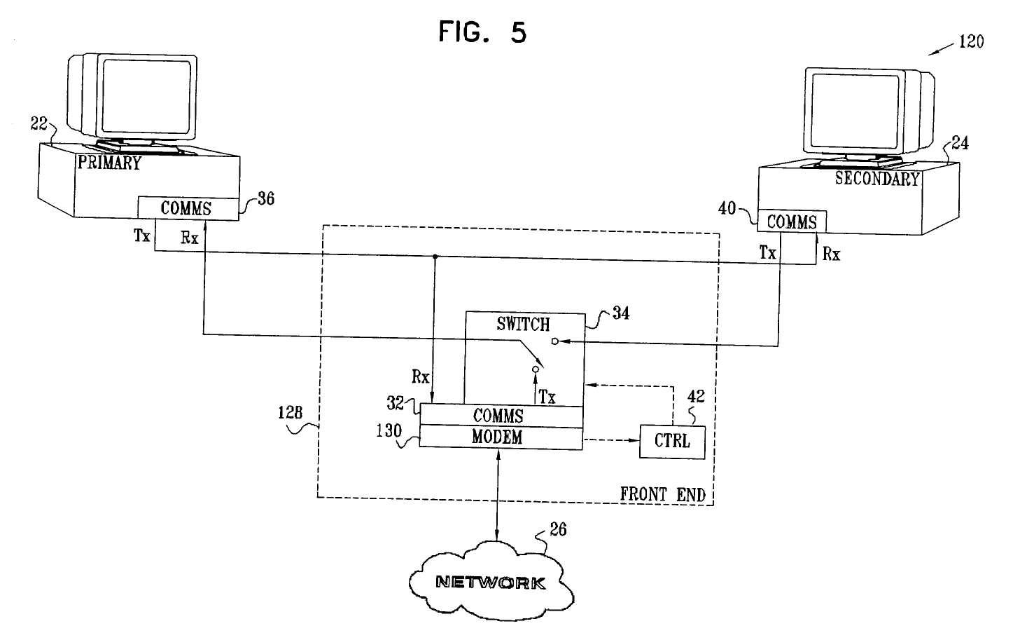

FIG. 5 is a block diagram that schematically illustrates a communication system 120 in which clients 22 and 24 share a common modem 130, in accordance with a preferred embodiment of the present invention. In this embodiment, a front end unit 128, which comprises modem 130, carries out all the signal processing functions required for communication between the clients and network 26. There is therefore no need for primary client 26 to run soft modem software, as in the preceding embodiments. Rather, primary client 22 simply receives data packets decoded by modem 130 and reads their destination addresses (typically IP addresses) in order to determine whether the address is its own. If so, the primary client retains the data. Otherwise, the primary client outputs the data to secondary client 24. In other respects, the operation of system 120 is substantially similar to that of system 20 shown in FIG. 1. System 70 (FIG. 3) and system 80 (FIG. 4) may be adapted to use a central modem in like fashion.

Although preferred embodiments are described hereinabove with reference to specific communication media and standards, the principles of the present invention may similarly be applied to other types of communication networks, including different broadband communication technologies, as well as narrowband technologies. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for data communications, comprising:
a modem front end, which is adapted to receive an incoming signal conveying incoming information over a communication medium, and to process the incoming signal so as to generate an incoming stream of incoming digitized samples, and which is further adapted to receive an outgoing stream of outgoing digital samples carrying outgoing information, and to process the outgoing digital samples to generate an outgoing signal for transmission over the communication medium;
a primary client, having an input and an output, the primary client being adapted to receive the incoming digitized samples via the input, to process the incoming digitized samples so as to extract the information from the incoming signal, and to convey the extracted information via the output to a secondary client, the primary client being further adapted to receive outgoing data via the input from the secondary client, to process the outgoing data so as to generate the outgoing stream of outgoing digital samples, and to convey the outgoing stream of outgoing digital samples via the output to the modem front end; and
a switch, coupled to the input of the primary client, and adapted to toggle between a first position in which the switch passes the incoming digital samples from the modem front end to the input, and a second position in which the switch passes the outgoing data from the secondary client to the input.

2. Apparatus according to claim 1, wherein the modem front end is coupled to control the switch.

3. Apparatus according to claim 2, wherein the modem front end is adapted to accumulate the incoming digitized samples while the switch is in the second position, and to cause the switch to toggle to the first position upon accumulating a predetermined volume of the incoming digitized samples.

4. Apparatus according to claim 2, wherein the modem front end and the primary and secondary clients are mutually coupled by a local area network (LAN), and wherein the input and output of the primary client respectively comprise a receive input and a transmit output of the primary client on the LAN, and wherein the secondary client is one of a plurality of secondary clients on the LAN, which are adapted to receive the extracted information from the primary client and to convey the outgoing data to the primary client over the LAN.

5. Apparatus according to claim 1, wherein the modem front end and the primary and secondary clients are mutually coupled by a local area network (LAN), and wherein the input and output of the primary client respectively comprise a receive input and a transmit output of the primary client on the LAN.

6. Apparatus according to claim 5, wherein the secondary client is one of a plurality of secondary clients on the LAN, which are adapted to receive the extracted information from the primary client and to convey the outgoing data to the primary client over the LAN.

7. Apparatus according to claim 1, wherein the modem front end and the secondary client are both coupled to receive the extracted information and the outgoing digital samples directly from the output of the primary client.

8. Apparatus according to claim 7, wherein the modem front end and the primary and secondary clients are mutually coupled by a local area network (LAN), and wherein the input and output of the primary client respectively comprise a receive input and a transmit output of the primary client on the LAN, and wherein the secondary client is one of a plurality of secondary clients on the LAN, which are adapted to receive the extracted information from the primary client and to convey the outgoing data to the primary client over the LAN.

9. Apparatus according to claim 1, wherein the primary client is adapted to process the extracted information to determine whether the information is intended for receipt by the primary client, and to convey the extracted information to the secondary client upon determining that the information is not intended for receipt by the primary client.

10. Apparatus according to claim 9, wherein the incoming information comprises a destination address, and wherein the primary client is adapted to extract the destination address from the extracted information and to determine whether the information is intended for receipt by the primary client responsive to the extracted destination address.

11. Apparatus according to claim 10, wherein the modem front end and the primary and secondary clients are mutually coupled by a local area network (LAN), and wherein the input and output of the primary client respectively comprise a receive input and a transmit output of the primary client on the LAN, and wherein the secondary client is one of a plurality of secondary clients on the LAN, which are adapted to receive the extracted information from the primary client and to convey the outgoing data to the primary client over the LAN.

12. Apparatus according to claim 1, wherein the outgoing data received by the primary client from the secondary client comprise first outgoing data, and wherein the primary client is adapted to create second outgoing data, and to process the second outgoing data, as well as the first outgoing data, to generate the outgoing stream of outgoing digital samples.

13. Apparatus according to claim 12, wherein the modem front end and the primary and secondary clients are mutually coupled by a local area network (LAN), and wherein the input and output of the primary client respectively comprise a receive input and a transmit output of the primary client on the LAN, and wherein the secondary client is one of a plurality of secondary clients on the LAN, which are adapted to receive the extracted information from the primary client and to convey the outgoing data to the primary client over the LAN.

14. Apparatus according to claim 1, wherein the primary and secondary clients comprise computers.

15. Apparatus for data communications, comprising:
a modem front end, which is adapted to receive an incoming signal conveying incoming information over a communication medium, and to process the incoming signal so as to generate an incoming stream of incoming digitized samples, and which is further adapted to receive an outgoing stream of outgoing digital samples carrying outgoing information, and to process the outgoing digital samples to generate an outgoing signal for transmission over the communication medium;
a plurality of clients having inputs and outputs, including a respective input and a respective output of each of the clients, each of the clients being adapted to receive the incoming digitized samples via the respective input and to process the incoming digitized samples so as to extract the information from the incoming signal, and being further adapted to process the outgoing information so as to generate the outgoing stream of outgoing digital samples and to convey the outgoing stream of outgoing digital samples via the respective output to the modem front end; and
a switch, coupled to toggle among the outputs of the clients so as to select one of the clients to convey the outgoing digital samples to the modem front end, while the inputs of all the clients are coupled simultaneously to receive the incoming digitized samples from the modem front end.

16. Apparatus according to claim 15, wherein the incoming information comprises a destination address, and wherein each of the clients has a respective address and is adapted to process the extracted information to determine whether the destination address matches its respective address, and to discard the extracted information if the destination address does not match the respective address.

17. Apparatus according to claim 15, wherein the modem front end and the clients are mutually coupled by a local area network (LAN), and wherein the respective input and output of each of the clients respectively comprise a receive input and a transmit output of each of the clients on the LAN.

18. Apparatus according to claim 15, wherein the clients comprise computers.

19. A method for data communications, comprising:
receiving an incoming signal at a modem front end, the signal conveying incoming information over a communication medium;
processing the incoming signal in the modem front end so as to generate an incoming stream of incoming digitized samples;
conveying the incoming digitized samples from the modem front end via a switch to an input of a primary client, while the switch is in a first position connecting the modem front end to the input of the primary client;
processing the incoming digitized samples in the primary client so as to extract the information from the incoming signal;
conveying the extracted information via an output of the primary client to a secondary client;
toggling the switch to a second position so as to connect the secondary client to the input of the primary client;
receiving outgoing data from the secondary client via the switch in the second position at the input of the primary client;
processing the outgoing data in the primary client so as to generate an outgoing stream of outgoing digital samples;
conveying the outgoing stream of outgoing digital samples via the output to the modem front end; and
processing the outgoing digital samples in the modem front end so as to generate an outgoing signal for transmission over the communication medium.

20. A method according to claim 19, wherein conveying the incoming digitized samples comprises toggling the switch to the first position responsive to the front end having the incoming digitized samples ready to convey to the primary client.

21. A method according to claim 20, wherein conveying the incoming digitized samples comprises accumulating the incoming digitized samples at the modem front end while the switch is in the second position, and wherein toggling the switch to the first position comprises actuating the switch when a predetermined volume of the incoming digitized samples has been accumulated.

22. A method according to claim 20, wherein the modem front end and the primary and secondary clients are mutually coupled by a local area network (LAN), and wherein the input and output of the primary client respectively comprise a receive input and a transmit output of the primary client on the LAN, and wherein the secondary client is one of a plurality of secondary clients on the LAN, which are adapted to receive the extracted information from the primary client and to convey the outgoing data to the primary client over the LAN.

23. A method according to claim 19, wherein the modem front end and the primary and secondary clients are mutually coupled by a local area network (LAN), and wherein the input and output of the primary client respectively comprise a receive input and a transmit output of the primary client on the LAN.

24. A method according to claim 23, wherein the secondary client is one of a plurality of secondary clients on the LAN, which are adapted to receive the extracted information from the primary client and to convey the outgoing data to the primary client over the LAN.

25. A method according to claim 19, wherein conveying the extracted information and conveying the outgoing stream of outgoing digital samples comprise conveying the extracted information and the outgoing digital samples to both the modem front end and the secondary client from the output of the primary client.

26. A method according to claim 25, wherein the modem front end and the primary and secondary clients are mutually coupled by a local area network (LAN), and wherein the input and output of the primary client respectively comprise a receive input and a transmit output of the primary client on the LAN, and wherein the secondary client is one of a plurality of secondary clients on the LAN, which are adapted to receive the extracted information from the primary client and to convey the outgoing data to the primary client over the LAN.

27. A method according to claim 19, wherein processing the incoming digitized samples comprises processing the extracted information in the primary client to determine whether the information is intended for receipt by the primary client, and wherein conveying the extracted information comprises passing the extracted information to the secondary client upon determining that the information is not intended for receipt by the primary client.

28. A method according to claim 27, wherein the incoming information comprises a destination address, and wherein processing the extracted information comprises extracting the destination address from the extracted information, and determining whether the information is intended for receipt by the primary client responsive to the extracted destination address.

29. A method according to claim 27, wherein the modem front end and the primary and secondary clients are mutually coupled by a local area network (LAN), and wherein the input and output of the primary client respectively comprise a receive input and a transmit output of the primary client on the LAN, and wherein the secondary client is one of a plurality of secondary clients on the LAN, which are adapted to receive the extracted information from the primary client and to convey the outgoing data to the primary client over the LAN.

30. A method according to claim 19, wherein receiving the outgoing data comprises receiving first outgoing data from the secondary client, and comprising creating second outgoing data in the primary client, wherein processing the outgoing data comprises processing both the first and second outgoing data to generate the outgoing stream of outgoing digital samples.

31. A method according to claim 30, wherein the modem front end and the primary and secondary clients are mutually coupled by a local area network (LAN), and wherein the input and output of the primary client respectively comprise a receive input and a transmit output of the primary client on the LAN, and wherein the secondary client is one of a plurality of secondary clients on the LAN, which are adapted to receive the extracted information from the primary client and to convey the outgoing data to the primary client over the LAN.

32. A method according to claim 19, wherein the primary and secondary clients comprise computers.

33. A method for data communications, comprising:
receiving an incoming signal at a modem front end, the signal conveying incoming information over a communication medium;
processing the incoming signal in the modem front end so as to generate an incoming stream of incoming digitized samples;
conveying the incoming stream of incoming digitized samples substantially simultaneously to a plurality of clients;
toggling a switch among a plurality of positions to select one of the clients, such that in each of the positions, an output of a respective one of the clients is connected to transfer an outgoing stream of outgoing digital samples to the modem front end;
conveying the outgoing stream of outgoing digital samples from the selected one of the clients to the modem front end; and
processing the outgoing digital samples in the modem front end so as to generate an outgoing signal for transmission over the communication medium;

34. A method according to claim 33, wherein the incoming information comprises a destination address, and wherein each of the clients has a respective address, and wherein the method comprises processing the incoming digitized samples in each of the clients so as to extract the incoming information from the incoming signal and to determine whether the destination address matches the respective address, and discarding the extracted information if the destination address does not match the respective address.

35. A method according to claim 33, wherein the modem front end and the clients are mutually coupled by a local area network (LAN), and wherein the respective input and output of each of the clients respectively comprise a receive input and a transmit output of each of the clients on the LAN.

36. A method according to claim 33, wherein the clients comprise computers.

37. Apparatus for data communications, comprising:
a modem, which is adapted to receive an incoming signal conveying incoming data over a communication medium, and to process the incoming signal so as to extract the incoming data therefrom, and which is further adapted to receive an outgoing stream of outgoing data, and to process the outgoing data to generate an outgoing signal for transmission over the communication medium;
a primary client, having an input and an output, the primary client being adapted to receive the incoming data via the input and to process the incoming data to determine whether the incoming data are intended for receipt by the primary client, and to convey the incoming data via the output to a secondary client upon determining that the data are not intended for receipt by the primary client, the primary client being further adapted to receive the outgoing data via the input from the secondary client, and to convey the outgoing data via the output to the modem front end; and
a switch, coupled to the input of the primary client, and adapted to toggle between a first position in which the switch passes the incoming data from the modem to the input, and a second position in which the switch passes the outgoing data from the secondary client to the input.

38. Apparatus according to claim 37, wherein the modem is coupled to control the switch.

39. Apparatus according to claim 38, wherein the modem is adapted to accumulate the incoming data while the switch is in the second position, and to cause the switch to toggle to the first position upon accumulating a predetermined volume of the incoming data.

40. Apparatus according to claim 37, wherein the modem and the secondary client are both coupled to receive the incoming and outgoing data directly from the output of the primary client.

41. Apparatus according to claim 37, wherein the data comprise data packets, and wherein the primary client is adapted to determine whether the data are intended for receipt by the primary client by examining an Internet Protocol (IP) address of the data packets.

42. Apparatus according to claim 37, wherein the outgoing data received by the primary client from the secondary client comprise first outgoing data, and wherein the primary client is adapted to create second outgoing data, and to convey the second outgoing data, as well as the first outgoing data, to the modem for generation of the outgoing signal responsive thereto.
